(19) United States
(12) Patent Application Publication
(10) Pub. No.: US 2024/0093939 A1
(43) Pub. Date: Mar. 21, 2024

(54) EFFICIENT HEAT PUMP EJECTOR VACUUM DRYER

(71) Applicant: THE CURATORS OF THE UNIVERSITY OF MISSOURI, Columbia, MO (US)

(72) Inventors: Hongbin Ma, Columbia, MO (US); Ramy Abdelhady, Columbia, MO (US); Shahabeddin K. Mohammadian, Columbia, MO (US); Jeremy Spitzenberger, Columbia, MO (US); Xiaoqin Susan Liu, Columbia, MO (US)

(21) Appl. No.: 18/467,310

(22) Filed: Sep. 14, 2023

Related U.S. Application Data
(60) Provisional application No. 63/375,990, filed on Sep. 16, 2022.

(51) Int. Cl. F26B 23/00; F26B 5/04

(52) U.S. Cl. CPC F26B 23/004; F26B 5/04; F26B 23/005; F26B 2210/16

(57) ABSTRACT

An efficient heat pump ejector vacuum dryer system and associated method of use for drying items that includes a drying vessel having a condenser and having a first evaporator where the first evaporator has an input that is connected to an output of the first expansion valve, a first expansion valve connected in fluid communication between the condenser and the first evaporator, a second expansion valve connected between the condenser and the second evaporator, a compressor having an input connected to an output of the first evaporator, an ejector that receives a vapor stream from an output of the compressor and receives a vapor stream from the output of the second evaporator generates as an output a high-temperature vapor provided to a condenser of the drying vessel to dry the items and generate an output of moisture, and a water reservoir that accumulates water from the drying vessel.

### CROSS REFERENCE TO RELATED APPLICATIONS

This application claims priority under 35 U.S.C. § 119 to provisional patent application U.S. Ser. No. 63/375,990, filed Sep. 16, 2022. The provisional patent application is herein incorporated by reference in its entirety, including without limitation, the specification, claims, and abstract, as well as any figures, tables, appendices, or drawings thereof.

### STATEMENT REGARDING FEDERALLY SPONSORED RESEARCH OR DEVELOPMENT

This invention was made with government support under grant number DE-AC05-00OR22725 awarded by the U.S. Department of Energy. The government has certain rights in the invention.

### TECHNICAL FIELD

The present invention solves the drawbacks of the current drying devices. It is a combined compressor-ejector heat pump system that integrates state-of-the-art technologies of the vapor compression cycle (heat pump), ejector cycle, and heat pipe (HP) to solve the high energy consumption and carbon emissions associated with traditional dryers. Thus, the objective of the present invention is to develop a vacuum dryer machine that could cut down on energy consumption and carbon emissions and operate reliably over a wide range of operating conditions.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Conventional vacuum wood dryers are typically batch, convective dry kilns. The green lumber (wood boards) with a high moisture content of up to 250% is stacked and separated in layers by metal plates. These wood boards are moved into a chamber, the doors closed, and lumber is exposed to a drying schedule. Steam is moved into chamber and through the air space formed by the metal plates and metal plates to heat up the lumber, transferring thermal energy to remove the moisture. This type of drying suffers from high operating costs because of the inefficient heating process, which accounts for over 55% of end-use onsite energy. Also, over three-quarters of the heating energy is supplied by steam produced onsite using gas furnaces, increasing carbon emissions.

The present invention relates to a lumber dryer that integrates the state-of-the-art technologies of an electrical-driven vapor compression cycle, ejector, and super-conductance oscillating heat pipe (OHP) with innovative designs of cap-end vapor refrigerant condensation heating, and highly-efficient water vapor condensation energy recovery unit to achieve extra-high energy efficiency while operating reliably over a wide range of operating conditions and achieves zero carbon emission. While the proposed dryer provides uniform heating power for wood drying, which can significantly shorten drying time from several weeks to several days, it can efficiently utilize the cooling and heating energy, achieving a closed energy loop.

Drying of materials is common in many industries, such as food, chemical, waste, and pharmaceutical product processing. It is an energy-intensive operation that could consume up to 60% of the total energy input required for the entire process. It also contributes to carbon emissions and greenhouse gases. Enhancing energy efficiency and reducing the emissions associated with this technology will significantly benefit energy conservation and greenhouse gas reduction, hence achieving the Federal Sustainability Plan, which aims to reach zero emissions by 2050.

Thus, there is a need in the art for an apparatus to dry materials that is energy efficient with a reduction in emissions and greenhouse gases.

### SUMMARY

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

The present invention relates to a lumber dryer that integrates the state-of-the-art technologies of an electrical-driven vapor compression cycle, ejector, and super-conductance oscillating heat pipe (OHP) with innovative designs of cap-end vapor refrigerant condensation heating, and highly-efficient water vapor condensation energy recovery unit to achieve extra-high energy efficiency while operating reliably over a wide range of operating conditions and achieves zero carbon emission. While the proposed dryer provides uniform heating power for wood drying, which can significantly shorten drying time from several weeks to several days, it can efficiently utilize the cooling and heating energy to achieve a closed energy loop.

It is a further object, feature, and/or advantage of the present disclosure is an efficient heat pump ejector vacuum dryer system for drying items that includes a drying vessel that includes a condenser section of a plurality of OHPs located between an evaporator section of the plurality of OHPs and secured within a housing, a condensed liquid tank that is in fluid connection to an output for the drying vessel, wherein the condensed liquid tank is in fluid connection to a first expansion valve and is in fluid connection to a second expansion valve, a first evaporator that has an input that is in fluid connection to an output of the first expansion valve, a second evaporator that has an input that is in fluid connection to an output of the second expansion valve, a compressor having an input that is in fluid connection to an output of the first evaporator, and an ejector that receives a primary high-pressure vapor stream from an output of the compressor and receives a secondary low-pressure vapor stream from the output of the second evaporator and generates as output a high-temperature vapor that is provided as input to a condenser section of the drying vessel to dry the items and generate an output of moisture.

It is still yet a further object, feature, and/or advantage of the present disclosure is a moisture condenser for receiving the moisture output from the drying vessel and transferring condensed water to a water reservoir, wherein the water reservoir is in fluid connection with a vacuum pump for retrieving the water from the moisture condenser into the water reservoir.

An aspect of the present disclosure is a pump for conveying cooling fluid from the moisture condenser to the second evaporator, then to the first evaporator, and finally return the cooling fluid to the moisture condenser.

Another aspect of the present disclosure is the items to be dried include wood or lumber.

Yet another aspect of the present disclosure is that wood or lumber does not crack due to the plurality of OHPs that provide a high level of temperature uniformity and thermal stress in the wood or lumber that reduces the drying process and prevents cracking.

Another feature of the present disclosure is a drying vessel is utilized to heat up the wood or lumber, where thermal energies removed from the first evaporator and the second evaporator are used to condense the moisture generated from the drying vessel and form the pressure difference to pump moisture from the drying vessel to the moisture condenser creating a closed-loop that results in increased thermal efficiency.

Yet another aspect of the present disclosure is that thermal energy received from the first evaporator and the compressor power the ejector, which pumps additional thermal energy from the second evaporator, resulting in high energy efficiency to reduce CO 2 emission from drying wood or lumber significantly and only utilizing electrical energy to drive the system.

Still, yet another feature of the present disclosure is that a vacuum pump is used only to remove the non-condensable gas only at the beginning when the lumber or wood is loaded into the drying vessel or some non-condensable gas from wood is produced during the operation of the drying vessel so that moisture flow from the drying vessel to the moisture condenser is by am evaporation-condensation closed loop that reduces power utilized by the vacuum pump.

Another feature of the present disclosure is a drying vessel having a condenser section of a plurality of OHPs secured within a housing that provides an inner surface that can facilitate heat transfer, having a thin layer film of liquid that can be removed by capillary force.

Still another aspect of the present disclosure is an efficient heat pump ejector vacuum dryer system for drying items that includes a drying vessel that includes a condenser and having a first evaporator located at the bottom of the drying vessel, a first expansion valve connected in fluid communication between the condenser and the first evaporator, a second expansion valve connected in fluid communication between the condenser and the second evaporator, a compressor having an input that is in fluid connection to an output of the first evaporator, an ejector that receives a primary high-pressure vapor stream from an output of the compressor and receives a secondary low-pressure vapor stream from the output of the second evaporator and generates as output a high-temperature vapor that is provided as input to the condenser of the drying vessel to dry the items and generate an output of water, and a water reservoir that accumulates the output of water from the bottom of the drying vessel.

A further feature of the disclosure is the condenser is secured within the drying vessel and having a condenser header that is in fluid communication with the first expansion valve, where a temperature difference between the condenser and the first evaporator reduces the pressure inside the drying vessel below atmospheric pressure to increase the rate of moisture removal and reduces the power consumption and drying time.

Still, another feature of the present disclosure is the drying vessel is a rotatable perforated drum located within a fixed drum, and the condenser is a stationary bundle of tubes.

Still yet another feature of the present disclosure is a vacuum pump in fluid communication with the drying vessel that is utilized to create an initial vacuum effect to reduce pressure below atmospheric pressure caused by a temperature difference between the first evaporator and the condenser and is able to maintain this vacuum pressure that results in a reduction in power consumption.

Another aspect of the present disclosure is the items to be dried are selected from the group consisting of food, grains, coffee beans, or wood chips.

An additional feature of the disclosure is a method for utilizing an efficient heat pump ejector vacuum dryer system for drying items that includes heating items in a drying vessel that includes a condenser secured within a housing, providing liquid from the output of the condenser to a first expansion valve that provides a low-pressure vapor to a first evaporator, providing liquid from the output of the condenser to a second expansion valve that creates a low-pressure liquid as input into a second evaporator that is converted into a low-pressure vapor, providing low-pressure vapor from the first evaporator fluid into a compressor, creating a high-pressure vapor, and utilizing an ejector that receives the high-pressure vapor stream from an output of the compressor and receives a secondary low-pressure vapor stream from the output of the second evaporator and generates as output a high-temperature vapor that is provided as input to a condenser section of the drying vessel to dry the items and generate an output of water.

Yet another feature of the method of the present disclosure is utilizing a condensed liquid tank that is connected in fluid relationship to the drying vessel.

It is still yet another feature of the method of the present disclosure that involves securing the first evaporator to the bottom of the drying vessel or integral thereto.

In still yet another aspect of the present disclosure is removing moisture output from the drying vessel and transferring condensed water to a water reservoir, wherein the water reservoir is in fluid connection to a vacuum pump for retrieving the water from the moisture condenser into the water reservoir.

Another feature of the method of the present disclosure is utilizing a rotatable perforated drum for the drying vessel located within a fixed drum and a stationary bundle of tubes for the condenser.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic of an efficient heat pump ejector vacuum dryer associated with the present disclosure.

FIG. 2 is a schematic of the energy flow of the efficient heat pump ejector vacuum dryer associated with the present disclosure.

FIG. 3 is a schematic side view of lumber or wood sandwiched between OHPs to provide uniform heating and a section thereof along Line A-A.

FIG. 4 is a schematic of an alternative embodiment of the efficient heat pump ejector vacuum dryer shown in FIG. 1 associated with the present disclosure with a flat plate condenser.

FIG. 5 is a schematic of an alternative embodiment of the efficient heat pump ejector vacuum dryer that utilizes a rotating perforated drum for a drying vessel located within a fixed drum and a stationary bundle of tubes for the condenser.

An artisan of ordinary skill in the art need not view, within the isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit the basic operation of the present disclosure unless otherwise indicated.

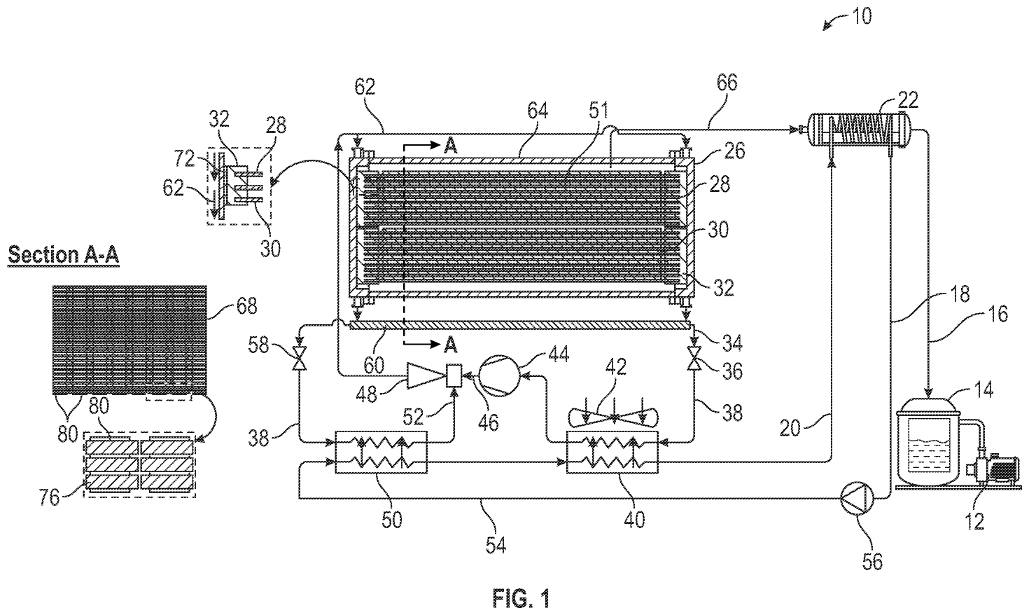

Referring now to FIG. 1, a heat pump ejector vacuum dryer is generally indicated by the numeral 10. This heat pump ejector vacuum dryer 10 includes an electrically driven compressor 44, two cap-end refrigerant vapor condensers 26 located on the left and right sides of a drying vessel 64, a first compact thin-film evaporator 40, a second compact thin-film evaporator 50, an ejector 48, flat-plate OHPs located within an OHP housing 32, a moisture condenser 22, a vacuum pump 12, and a water reservoir 14.

An oscillating heat pipe (OHP), also known as a pulsating heat pipe, is only partially filled with liquid working fluid. The pipe is arranged in a serpentine pattern in which freely moving liquid and vapor segments alternate. Oscillation takes place in the working fluid; the pipe remains motionless. A compressor is defined as a device that packs molecules in the gas-based refrigerant tightly together, a process that raises both the temperature and pressure of the refrigerant. A condenser is the outdoor portion of an air conditioner or heat pump that either releases or collects heat, depending on the time of the year. An ejector is defined as utilizing a principle of operation based on the Venturi effect of a converging-diverging nozzle to convert the pressure energy of a motive fluid, functioning as a primary flow, to kinetic energy to entrain a suction fluid, functioning as a secondary flow, and then recompress the mixed fluids by converting kinetic energy back into pressure energy.

Ejectors are thermally activated static compressors and consist of a nozzle (a primary convergent-divergent nozzle) embedded in a main, generally cylindrical, body. The compression effect results from the interaction of the two fluid streams. The motive stream is at high pressure and is produced in a generator using a heat source. This heat source can come from low-grade temperature heat. Therefore, ejectors thus have the advantage that they can be driven with waste heat and used as heat pumps in appropriate cycles to produce heat upgrading, cooling, or refrigeration effects, provided as long as a thermal source is available.

The throttle valve is a mechanical device whose function is to regulate and maintain the downstream pressure so that the inlet conditions for the expansion are constant. It does this by introducing a flow restriction, inducing a significant localized pressure drop in the refrigerant. The evaporator holds the chilled refrigerant that the compressor moves into it. As the air from the blower fan moves over the coil, the cold refrigerant removes the heat from a building's air. The refrigerant becomes warmer and travels to the condenser coil outdoors. With a heat pump, the process reverses in the winter, and the evaporator coil expels heat from the refrigerant into the building instead of absorbing it and taking it outdoors.

The compressor 44 is electrically driven to compress the refrigeration vapor generated from the first compact thin-film evaporator 40 having an air flow 42. The energy added by the compressor 44 and the thermal energy received from the first compact thin-film evaporator 40 is in a low-pressure liquid state 38 that is then converted into a compressed high-pressure refrigerant vapor in a high-pressure vapor state 46, which is used to power the ejector 48.

In the ejector 48, the compressed refrigerant vapor goes through a convergent-divergent nozzle, and a supersonic flow is produced, resulting in low-pressure vapor in the ejector 48 that is in fluid connection with the second compact thin-film evaporator 50, where refrigerant evaporation occurs, and additional thermal energy is added to the system.

The stream brings all the energy in a hot stream from the compressor 44, the first compact thin-film evaporator 40, and the second compact thin-film evaporator 50 to the two cap-end refrigerant vapor condensers 26 in the form of high-temperature vapor 62, where the refrigerant vapor condenses, and the thermal energy is released and transferred to the wood or lumber 76 by flat-plate OHPs that are generally indicated by numeral 51. The inner surface of the condenser section of OHPs 30 can be selected from the commercially available condensation surfaces to effectively condense vapor to liquid, such as, but not necessarily, a grooved enhanced condenser section of OHPs 30.

The released thermal energy due to condensation is directly transferred to the evaporator section 28 of flat-plate OHPs 51 located in the OHP housing 32. The OHPs housing 32 provides perfect thermal contact between OHPs and cap-end refrigerant vapor condensers 26, allowing heat transfer efficiently. Through the oscillating motion and phase change heat transfer of the working fluid in the flat-plate OHPs located in the OHP housing 32, the thermal energy is efficiently transferred to the OHP's condenser section 30, which are in direct contact with lumber or wood 76 to uniformly heat up and dry the lumber or wood 76 in the drying vessel 64.

Liquid from drying vessel 64 is provided to a condensed liquid tank 60. This liquid 34 from the condensed liquid tank 60 passes to a first expansion valve 36 that is in a fluid relationship with the first compact thin-film evaporator 40 and provides low-pressure liquid thereto. Moreover, this liquid 34 from the condensed liquid tank 60 passes to a second expansion valve 58 that is in a fluid relationship with the second compact thin-film evaporator 50 and provides a low-pressure liquid 38 thereto.

The first compact thin-film evaporator 40 includes a fan 42 that is used to add more energy from the atmosphere at the startup (base load) when moisture has not been regenerated yet in the drying vessel 64. When the cycle reaches a steady state, moisture starts to be released from the wood or lumber 76 in the drying vessel 64 and flows through small gaps formed by the thin flat-plate OHPs 51 located in the OHP housing 32, which provides heating energy and functions as spacers simultaneously to the moisture condenser 22 through the moisture outlet of the drying vessel 66.

In the moisture condenser 22, the moisture is condensed into water in a condensed water line 16, and the released thermal energy is collected by the cooling fluid 54, which is thermally connected with the first compact thin-film evaporator 40 and the second thin-film evaporator 50, where the thermal energy is then recovered and pumped back to the system. At the same time, the condensate is collected in a water reservoir 14 as a by-product (potable water).

There is cooling fluid 54 that circulates from outlet 18 into the fluid pump 56 through the second compact thin-film evaporator 50 and then the first compact thin-film evaporator 40 and then returns into an input 20 of the fluid pump 56.

A vacuum pump 12 is used to remove the non-condensable gases. Using the pressure and temperature readings in drying vessel 64 and moisture condenser 22, the amount of non-condensable gases can be readily determined, which is similar to a typical heat pipe. The vacuum pump 56 is switched on only when the non-condensable gases in the system reach a level. In this way, the power usage from the vacuum pump 12 is significantly reduced, which is much smaller than commercially available vacuum wood dryers in the marketplace.

Also, this system 10 can optionally be equipped with a smart control system (SCS) using machine learning and optimization algorithms (not shown). The SCS will identify the operating parameters that optimize product quality and reduce energy consumption and operation costs simultaneously.

Also, in FIG. 1, a sectional view through line A-A shows the OHPs housing 32, the condenser section of the OHPs 30, and the evaporator section of the OHPs 28. This is in addition to the thermal tape 72 as well as showing the high-temperature vapor 62 coming off the ejector 48. In addition, also shown is stacking 68 of the wood or lumber 76 in relation to the flat-plate OHPs 51, and the wood or lumber 76 is generally indicated by the numeral 80.

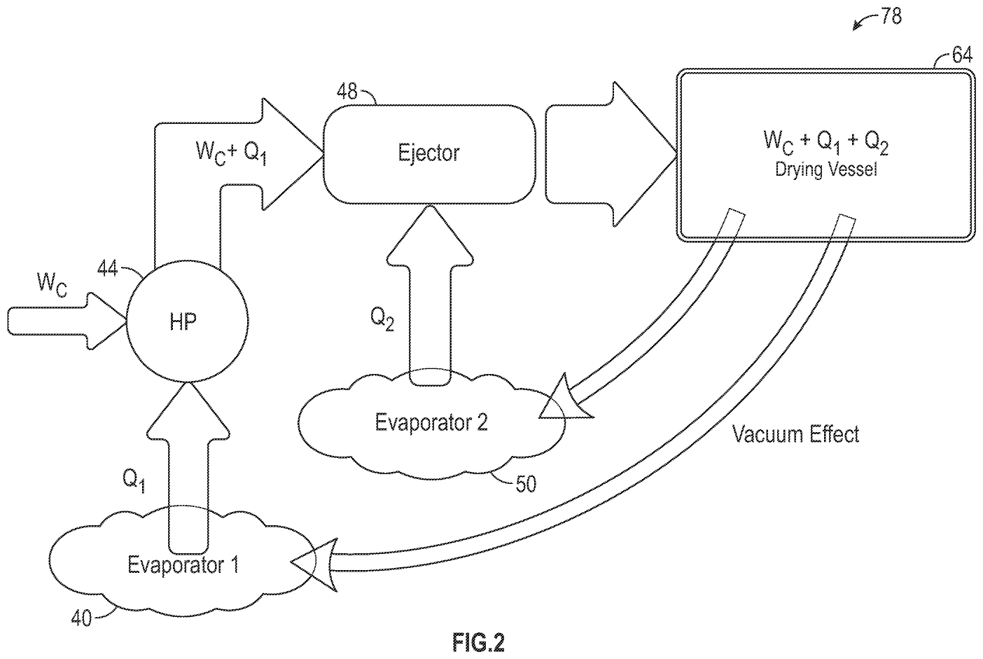

Referring now to FIG. 2, the energy flow of the heat pump ejector vacuum dryer system is generally indicated by the numeral 78. As shown, compressor 44 is the system's prime mover, operated by electricity only, and no energy is wasted for the whole system. The proposed dryer will have extra-high thermal efficiency, unmatched by any existing technology. The drying vessel 64 provides a vacuum effect to the first thin-film evaporator 40, with Q₁ being the heat transferred to and from the first thin-film evaporator 40. Q₂ is the heat being transferred to and from the second thin-film evaporator 50 from the drying vessel 64 Q₁ plus the work W_{c} done by the system with the compressor 44 combined with Q₂ in the ejector 48 results in the combination of W_{c} and Q₁ and Q₂ in the drying vessel 64.

This heat pump ejector vacuum dryer includes a vapor compression cycle, an ejector, and preferably, but not necessarily includes (depending on the application, oscillating heat pipes (OHP), and cap-end condensers. These three technologies are integrated effectively with a highly efficient vapor-water condensation energy recovery unit. The ejector 48 is effectively integrated into the vapor compression cycle to utilize further the thermal energy released in a condenser 30 in a typical vapor compression cycle to entrain additional thermal energy into the system, and both “hot” and “cold” thermal energies are efficiently utilized. This novel high-temperature vapor-compression-ejector heat pump uses low Global Warming Potential (GWP) refrigerants (<10) and zero Ozone Depletion Potential (ODP). While the flat-plate OHP can function as thin spacers for stacking lumber 68, OHP's extra-high effective thermal conductivity can produce an extra-high level of temperature uniformity of lumber or wood 76 in the drying vessel 64, which can significantly reduce drying time. The thin-film evaporator utilizing thin-film evaporation can result in highly efficient compact evaporators 40 and 50, which can efficiently utilize the thermal energy from the ambient air as well as the thermal energy recovered from the wood water vaporization through a moisture condenser. The refrigerant vapor condenser 30 utilizes a state-of-the-art engineered surface to enhance the condensation of refrigerant vapor coming from ejector 48 and compressor 44, and the thermal energy released from the condensation can be efficiently and uniformly transported to the wood lumbers through the high-conductance flat-plate OHPs 51 in the vessel.

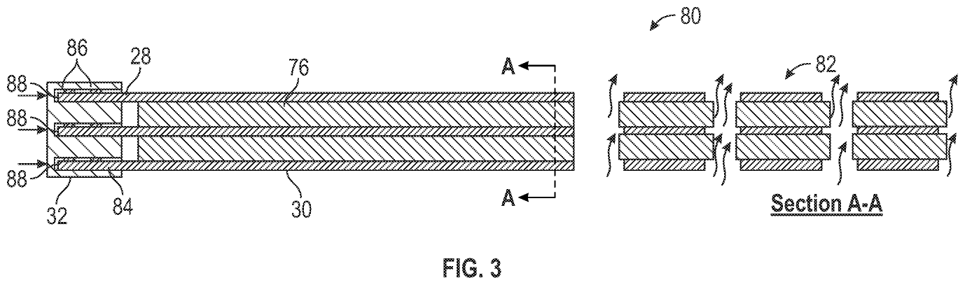

Referring now to FIG. 3, lumber or wood sandwiched between OHPs is generally shown by the numeral 80. The wood or lumber 76 is positioned in relationship to the OHPs' condenser section 30. The OHPs evaporator section 28 with push pins 86 provides good contact 84 with the OHPs housing 32. The heat 88 from the cap end of the condenser 26 is also shown. This provides uniform heating. A line Section A-A is shown to show moisture regeneration 82.

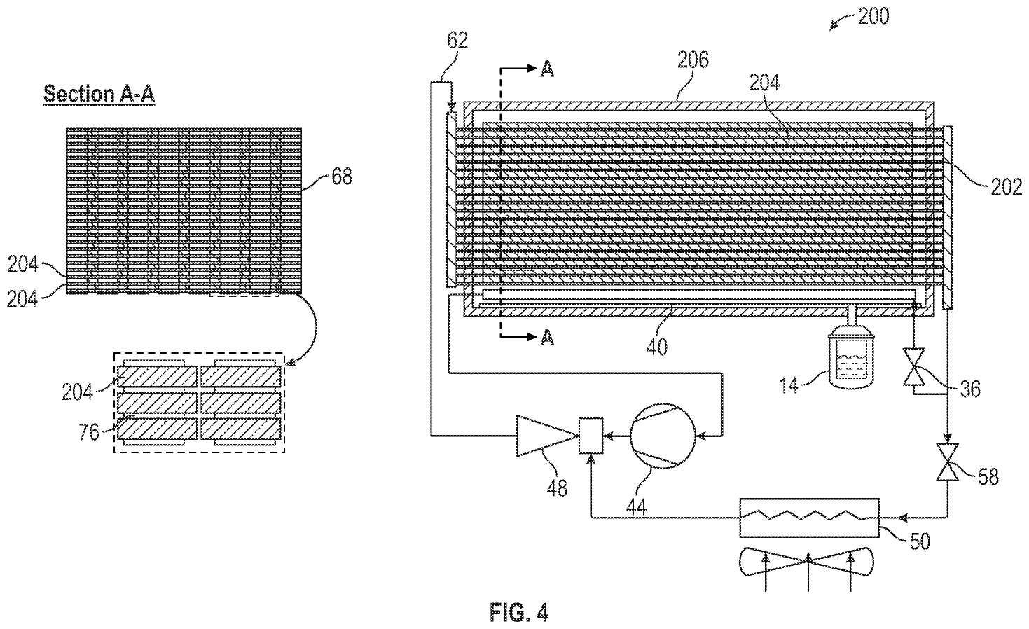

Referring now to FIG. 4, an alternative embodiment of a drying vessel with a flat plate condenser for lumber board is generally indicated by the numeral 200. In this design, the high-temperature vapor 62 comes out from the ejector 48 and goes to flat-plate condenser 204, which is in direct contact with wood or lumber 76. The high-temperature vapor 62 releases thermal energy to dry the wood or lumber 76, removing the moisture. There is a condenser header 202 connected in fluid relationship to the condenser 204 that is connected to or potentially integral therewith. This condenser header 202 is connected in fluid communication to an input for a first expansion valve 36 that converts liquid into a low-pressure liquid. The output for the second expansion valve 58 is connected in fluid connection to a second compact, thin film evaporator 50 that converts the liquid into a low-pressure vapor state that creates a secondary pressure stream for input into an ejector 48.

The condenser header 202 also provides liquid to a first expansion valve 36 and is in fluid communication therewith and reduces the pressure of the liquid. The output of the first expansion valve 36 lowers the pressure of the liquid and is connected to the input of a first compact thin film evaporator 40 that is preferably, but not necessarily, located at the bottom of the flat plate drying vessel 206. This drying vessel might have any type of shape such as round, square, and so forth and should not be limited by any means to being a flat plate. This first compact thin film evaporator 40 creates low-pressure vapor and is connected in fluid relationship to the input of a compressor 44 that converts the low-pressure vapor into high-pressure vapor. The output of the compressor 44 is connected in fluid relationship to the ejector 48 and provides the primary stream into an input for the ejector 48.

The moisture is condensed by touching the surface of the first compact thin film evaporator 40. The output of the first compact thin film evaporator 40 provides a low-pressure vapor and is in a fluid relationship with a compressor 44. The compressor 44 converts the low-pressure vapor into high-pressure vapor and provides the primary stream to the ejector 48 in addition to the secondary stream from the second compact thin film evaporator 50. The ejector 48 provides a high-pressure vapor stream 62 that is returned to the flat plate drying vessel 206. The liquid extracted from the wood or lumber 76 in the drying vessel 206 goes into a water reservoir 14. The temperature difference between the flat plate condenser 204 and the first compact thin film evaporator 40 reduces the pressure inside the drying vessel 206 below the atmospheric pressure. This reduction in the pressure increases the moisture removal rate as part of the drying process and, therefore, reduces the power consumption and drying time. The aspect of FIG. 4 taken along Line A-A includes a wood stacking 68, the flat plate condenser 204, and the wood or lumber 76.

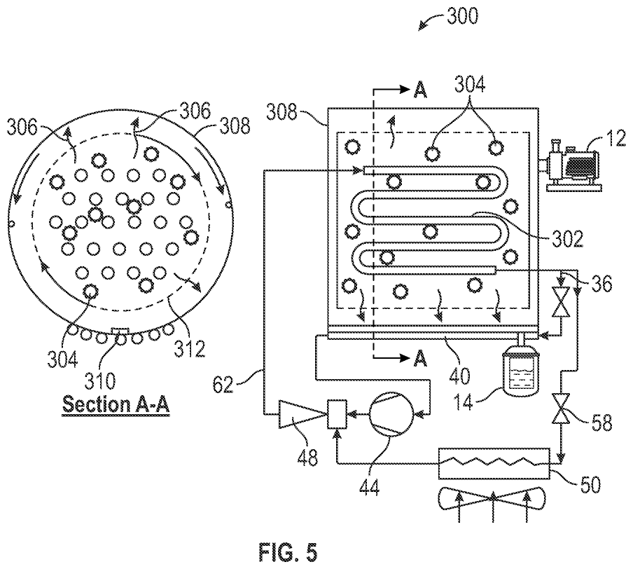

Referring now to FIG. 5, an alternative embodiment of a drying vessel with a tube condenser and rotating drum is generally indicated by numeral 300. In this design, the high-temperature vapor 62 comes out from the ejector 48 and goes to a stationary or rotating tube condenser 302. This design is for a whole host of other drying applications, including, but not limited to, food, grains, coffee beans, and wood chips. The condenser is changed to be a stationary bundle of tubes 302, where the thermal energy is rejected to the material during drying. There is a perforated rotating or stationary drum 312 where the perforations remove moisture 306 from the material and escapes and condenses over the surface of the evaporator 40 setting in the bottom of fixed drum 308 in the form of condensed water 310.

The high-temperature vapor 62 releases thermal energy to dry the materials, e.g., wood chips 304, and the moisture 306 is removed. The stationary tube condenser 302 is connected in fluid communication to an input for a second expansion valve 58 that converts liquid into low-pressure liquid. The output for the second expansion valve 58 is connected in fluid connection to a second compact, thin film evaporator 50 that converts the liquid into a low-pressure vapor state that creates a secondary pressure stream for input into an ejector 48.

The stationary tube condenser 302 also provides liquid to a first expansion valve 36 and is in fluid communication therewith and reduces the pressure of the liquid. The output of the first expansion valve 36 lowers the pressure of the liquid and is connected to the input of a first compact thin film evaporator 40 that is preferably, but not necessarily, located at the bottom of the fixed drum 308. This first compact thin film evaporator 40 creates low-pressure vapor and is connected in fluid relationship to the input of a compressor 44 that converts the low-pressure vapor into high-pressure vapor. The output of the compressor 44 is connected in fluid relationship to the ejector 48 and provides the primary stream into an input for the ejector 48.

The moisture is condensed by touching the surface of the first compact thin film evaporator 40. The output of the first compact thin film evaporator 40 provides a low-pressure vapor and is in a fluid relationship with a compressor 44. The compressor 44 converts the low-pressure vapor into high-pressure vapor and provides the primary stream to the ejector 48 in addition to the secondary stream from the second compact thin film evaporator 50. The ejector 48 provides a high-pressure vapor stream 62 that is returned to the stationary tube condenser 302.

The liquid extracted from the materials, e.g., wood chips 304, obtained from the perforated rotating drum 312 and into the bottom of the fixed drum 308, goes into a water reservoir 14.

A vacuum pump 12 is used at the beginning of the operation to create a vacuum effect that reduces the pressure before the atmospheric pressure. The temperature difference between the first compact thin film evaporator 40 and the stationary tube condenser 302 would be able to maintain this vacuum pressure, significantly reducing power consumption.

The aspect of FIG. 5 taken along Line A-A includes the fixed drum 308 surrounding the perforated rotating drum 312 with illustrative, but nonlimiting, wood chips 304 located within the perforated rotating drum 312 with the extraction of moisture 306 and the creation of condensed water 310. There are a wide variety of motorized mechanisms that can be deployed to rotate the perforated rotating drum 312 or rotating condenser 302.

An important aspect of the present disclosure includes that Both “hot” and “cold” thermal energy is fully utilized. When the thermal energy is pumped to a higher heat source, i.e., the dry vessel, it is fully utilized to heat up and dry the material, e.g., wood or lumber 76. At the same time, the thermal energies removed from both evaporators 40 and 50 (the cooling capacities) are used to condense the moisture generated from the dry vessel and form the pressure difference to pump the moisture from a hot dry vessel to a cold condenser. This closed-loop results in a further increase in thermal efficiency.

Another important aspect of the present invention is that oscillating heat pipes (OHPs) are heating elements and spacers, significantly reducing the drying time with no wood or lumber 76 cracking. A big challenge in traditional wood dryers is to prevent wood cracking due to the thermal stress produced by the temperature difference during the drying process. The flat-plate OHPs as heating elements and spacers will provide a high level of temperature uniformity, and thermal stress in the lumber can be significantly reduced during the drying process, preventing cracking.

An additional aspect of the present disclosure is this is an eco-friendly system that can result in extra-high thermal efficiency. For a typical vapor-compression cycle, the compressed vapor flows into the condenser, where heat is dumped into the ambient air. For the proposed system, the compressed refrigeration vapor, which brings the thermal energy received from the first compact thin film evaporator 40 and the compressor 44 work, is further utilized to power the ejector 48, which pumps additional thermal energy from the second compact thin film evaporator 50, resulting in high energy efficiency. It can directly replace the gas-fired boilers without system retrofitting and significantly reduce the CO 2 emission in wood or lumber 76 drying. With the aim of decarbonization, only electrical energy will be utilized to drive the system.

Still, yet another aspect of the present disclosure is that the power the vacuum pump 12 uses can be significantly reduced. For a typical vacuum dryer, the vacuum pump is used to pump moisture from the drying vessel and, at the same time, maintain a higher level of vacuum, resulting in a high operation cost, which explains why a typical vacuum dryer is so expensive. For this system, the vacuum pump 12 is used only to remove the non-condensable gas. In other words, the vacuum pump 12 in this system runs only at the beginning when the wood or lumber 76 is loaded, or some non-condensable gas from wood is produced during the operation. The moisture flow from the drying vessel to the moisture condenser is by the evaporation-condensation closed loop, similar to a typical heat pipe. Therefore, the power of the vacuum pump can be significantly reduced.

In addition, an outhandling feature is that a by-product (freshwater) can be produced. For a typical wine barrel wood, the moisture should be reduced from about 50% to 12%. The proposed dryer with a typical size, for example, a load capacity of 4000 Board Feet (9.44 m3), can generate fresh water up to 294,000 gallons of water per year per dryer at an annual production rate of 1,100 MBF.

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 10 | Heat pump ejector vacuum dryer |
| 12 | Vacuum pump |
| 14 | Water reservoir |
| 16 | Condensed water line |
| 18 | Output of moisture collector |
| 20 | Input of moisture collector |
| 22 | Moisture condenser |
| 26 | Cap-end refrigerant vapor condenser |
| 28 | Evaporator section of OHPs |
| 30 | Condenser Section of OHPs |
| 32 | OHPs housing |
| 34 | Liquid |
| 36 | First expansion valve |
| 38 | Low-pressure liquid |
| 40 | First compact thin-film evaporator |
| 42 | Fan for airflow for first evaporator |
| 44 | Compressor |
| 46 | High-pressure vapor state |
| 48 | Ejector |
| 50 | Second compact thin-film evaporator |
| 51 | Flat-plate OHPs |
| 52 | Low-pressure vapor state |
| 54 | Cooling fluid |
| 56 | Fluid pump |
| 58 | Second expansion valve |
| 60 | Condensed liquid tank |
| 62 | High-temperature vapor |
| 64 | Drying vessel |
| 66 | Moisture output of drying vessel |
| 68 | Wood stacking |
| 72 | Thermal tape |
| 76 | Woods or lumber |
| 78 | Energy flow of heat pump ejector vacuum dryer system |
| 80 | Lumber sandwiched between OHPs to provide uniform heating |
| 82 | Moisture regeneration |
| 84 | Good contact |
| 86 | Push pins |
| 88 | Heat from the cap-end condenser |
| 200 | Drying vessel with flat plate condenser for lumber board. |
| 202 | Condenser header |
| 204 | Flat plate condenser |
| 206 | Drying vessel |
| 300 | Drying vessel with a tube condenser and rotating drum |
| 302 | Stationary tube condenser |
| 304 | Wood chips |
| 306 | Moisture |
| 308 | Fixed drum |
| 310 | Condensed water |
| 312 | Perforated rotating drum |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An efficient heat pump ejector vacuum dryer system for drying items comprising of:
a drying vessel that includes a condenser section of a plurality of OHPs located between an evaporator section of the plurality of OHPs and secured within a housing;
a condensed liquid tank that is in fluid connection to an output for the drying vessel, wherein the condensed liquid tank is in fluid connection to a first expansion valve and is in fluid connection to a second expansion valve;
a first evaporator that has an input that is in fluid connection to an output of the first expansion valve;
a second evaporator that has an input that is in fluid connection to an output of the second expansion valve;
a compressor having an input that is in fluid connection to an output of the first evaporator; and
an ejector that receives a primary high-pressure vapor stream from an output of the compressor and receives a secondary low-pressure vapor stream from the output of the second evaporator and generates as output a high-temperature vapor that is provided as input to a condenser section of the drying vessel to dry the items and generate an output of moisture.

2. The efficient heat pump ejector vacuum dryer system for drying items according to claim 1, further comprising a moisture condenser for receiving the moisture output from the drying vessel and transferring condensed water to a water reservoir, wherein the water reservoir is in fluid connection with a vacuum pump for retrieving the water from the moisture condenser into the water reservoir.

3. The efficient heat pump ejector vacuum dryer system for drying items according to claim 2, further comprising a pump for conveying cooling fluid from the moisture condenser to the second evaporator, then to the first evaporator, and finally return the cooling fluid to the moisture condenser.

4. The efficient heat pump ejector vacuum dryer system for drying items according to claim 1, wherein the items to be dried includes wood or lumber.

5. The efficient heat pump ejector vacuum dryer system for drying items according to claim 4, wherein the wood or lumber does not crack due to the plurality of OHPs that provide a high level of temperature uniformity and thermal stress in the wood or lumber that reduces the drying process and prevents cracking.

6. The efficient heat pump ejector vacuum dryer system for drying items according to claim 1, wherein the drying vessel is utilized to heat up the wood or lumber, where thermal energies removed from the first evaporator and the second evaporator are used to condense the moisture generated from the drying vessel and form the pressure difference to pump moisture from the drying vessel to the moisture condenser creating a closed-loop that results in increased thermal efficiency.

7. The efficient heat pump ejector vacuum dryer system for drying items according to claim 1, wherein the thermal energy received from the first evaporator and the compressor power the ejector, which pumps additional thermal energy from the second evaporator, resulting in high energy efficiency to reduce CO 2 emission from drying wood or lumber significantly and only utilizing electrical energy to drive the system.

8. The efficient heat pump ejector vacuum dryer system for drying items according to claim 2, wherein the vacuum pump is used only to remove the non-condensable gas only at the beginning when the lumber or wood is loaded into the drying vessel or some non-condensable gas from wood is produced during the operation of the drying vessel so that moisture flow from the drying vessel to the moisture condenser is by am evaporation-condensation closed loop that reduces power utilized by the vacuum pump.

9. The efficient heat pump ejector vacuum dryer system for drying items according to claim 1, wherein the drying vessel having a condenser section of a plurality of OHPs secured within a housing provides an inner surface that can facilitate heat transfer and having a thin layer film of liquid that can be removed by capillary force.

10. An efficient heat pump ejector vacuum dryer system for drying items comprising of:
a drying vessel that includes a condenser and having a first evaporator located at the bottom of the drying vessel;
a first expansion valve connected in fluid communication between the condenser and the first evaporator;
a second expansion valve connected in fluid communication between the condenser and the second evaporator;
a compressor having an input that is in fluid connection to an output of the first evaporator;
an ejector that receives a primary high-pressure vapor stream from an output of the compressor and receives a secondary low-pressure vapor stream from the output of the second evaporator and generates as output a high-temperature vapor that is provided as input to the condenser of the drying vessel to dry the items and generate an output of water; and
a water reservoir that accumulates the output of water from the bottom of the drying vessel.

11. The efficient heat pump ejector vacuum dryer system for drying items according to claim 10, wherein the condenser is secured within the drying vessel and having a condenser header that is in fluid communication with the first expansion valve where a temperature difference between the condenser and the first evaporator reduces the pressure inside the drying vessel below atmospheric pressure to increase the rate of moisture removal and reduces the power consumption and drying time.

12. The efficient heat pump ejector vacuum dryer system for drying items according to claim 10, wherein the items to be dried includes wood or lumber.

13. The efficient heat pump ejector vacuum dryer system for drying items according to claim 10, wherein the drying vessel is a rotatable perforated drum located within a fixed drum, and the condenser is a stationary bundle of tubes.

14. The efficient heat pump ejector vacuum dryer system for drying items according to claim 13, further comprising a vacuum pump in fluid communication with the drying vessel that is utilized to create an initial vacuum effect to reduce pressure below atmospheric pressure caused by a temperature difference between the first evaporator and the condenser and is able to maintain this vacuum pressure that results in a reduction in power consumption.

15. The efficient heat pump ejector vacuum dryer system for drying items according to claim 13, wherein the items to be dried are selected from the group consisting of food, grains, coffee beans, or wood chips.

16. A method for utilizing an efficient heat pump ejector vacuum dryer system for drying items comprising of:
heating items in a drying vessel that includes a condenser secured within a housing;
providing liquid from the output of the condenser to a first expansion valve that provides a low-pressure vapor to a first evaporator;
providing liquid from the output of the condenser to a second expansion valve that creates a low-pressure liquid as input into a second evaporator that is converted into a low-pressure vapor;
providing low-pressure vapor from the first evaporator fluid into a compressor, creating a high-pressure vapor; and
utilizing an ejector that receives the high-pressure vapor stream from an output of the compressor and receives a secondary low-pressure vapor stream from the output of the second evaporator and generates as output a high-temperature vapor that is provided as input to a condenser section of the drying vessel to dry the items and generate an output of water.

17. The method for utilizing an efficient heat pump ejector vacuum dryer system for drying items according to claim 16, further comprising utilizing a condensed liquid tank that is connected in fluid relationship to the drying vessel.

18. The method for utilizing an efficient heat pump ejector vacuum dryer system for drying items according to claim 16, further comprising securing the first evaporator to the bottom of the drying vessel or integral thereto.

19. The method for utilizing an efficient heat pump ejector vacuum dryer system for drying items according to claim 16, further comprising removing moisture output from the drying vessel and transferring condensed water to a water reservoir, wherein the water reservoir is in fluid connection to a vacuum pump for retrieving the water from the moisture condenser into the water reservoir.

20. The method for utilizing an efficient heat pump ejector vacuum dryer system for drying items according to claim 18, further comprising utilizing a rotatable perforated drum for the drying vessel located within a fixed drum and a stationary bundle of tubes for the condenser.
